(19) United States
(12) Patent Application Publication
(10) Pub. No.: US 2026/0117814 A1
(43) Pub. Date: Apr. 30, 2026

(54) HOOK ASSEMBLY AND OBJECT HANGING DEVICE INCLUDING THE HOOK ASSEMBLY

(71) Applicant: TRANSIN BIOMEDICAL CO., LTD., Taoyuan City (TW)

(72) Inventors: CHIEH-MAO LIN, Taoyuan City (TW); TZU-HSUAN HUANG, Taoyuan City (TW); YI-JHE WU, Taoyuan City (TW)

(73) Assignee: TRANSIN BIOMEDICAL CO., LTD., Taoyuan City (TW)

(21) Appl. No.: 18/963,538

(22) Filed: Nov. 28, 2024

(30) Foreign Application Priority Data
Oct. 28, 2024 (TW) 113141041

(51) Int. Cl. F16B 45/00; A47G 29/08; F16B 2/10

(52) U.S. Cl. CPC F16B 45/00; A47G 29/08; F16B 2/10

(57) ABSTRACT

The present application provides a hook assembly including: a first combination element, having a first head protruding portion having a first front half engaging slot and a first tail connecting portion having a first rear half engaging slot; a second combination element, having a second head protruding portion having a second front half engaging slot and a second tail connecting portion having a second rear half engaging slot; a first object hanging element having a first coupling portion detachably connected at the first front half engaging slot and the second rear half engaging slot; a second object hanging element, having a second coupling portion detachably connected at the second front half engaging slot and the first rear half engaging slot. An object hanging device including the hook assembly above is further provided.

### CROSS-REFERENCE TO RELATED APPLICATION

This non-provisional application claims priority under 35 U.S.C. § 119(a) on Patent Application No(s). 113141041 filed in Taiwan, R.O.C. on Oct. 28, 2024, the entire contents of which are hereby incorporated by reference.

### BACKGROUND OF THE INVENTION

### 1. Field of the Invention

The present disclosure relates to an assembly and a device including the assembly, and in particular to a hook assembly and an object hanging device including the hook assembly.

### 2. Description of the Related Art

In general, a hospital bed drainage bag hook for the use of a patient is arranged at a lower part of a bed. In practice, in order to prevent tripping of a patient while the patient gets off a bed, the height of the bed is usually reduced to a lowest height possible. At this point, an outlet of the drainage bag (for example, a urine bag) may easily come into contact with the ground. If the patient is in a hurry to get off the bed, the existence of the urine bag may be overlooked, causing pulling of pipelines of the drainage bag. Moreover, nurses and caregivers often need to observe and/or pour out the contents of the drainage bag. Such an operation conducted with frequent squatting down may be extremely inconvenient for elderlies, and may easily increase risks of falling of the elderlies. To prevent the above issues, a patient intending to get off a bed usually first hangs the drainage bag on a drainage bag hook at a lower part a mobile infusion stand.

However, even if a patient hangs the drainage bag on a drainage bag hook at a lower part of a mobile infusion stand, it is discovered in practice that a connecting tube of the drainage bag often gets wound around the mobile infusion stand, such that the length of the connecting tube of the drainage bag gets shorter and shorter, further resulting in pulling of pipelines or even affecting drainage due to the twisted and bent pipelines. In addition, walking may also be made difficult for a user in practice, similarly further increasing risks of falling of the patient. It is concluded after analysis that, one of the main reasons causing winding of a connecting tube of a drainage bag is because movable casters at a base of a mobile infusion stand are universal wheels (the mobile infusion stand is movable 360° in contribution to the universal wheels).

In order to solve the occurrence of a connecting tube of a drainage bag becoming wound around a mobile infusion stand, the mobile infusion stand is often moved in a direction opposite to the winding direction in practice, so that the connecting tube of the drainage bag no longer winds around the mobile infusion stand. As an alternative, if a drainage bag hook is detachably connected to a mobile infusion stand, the drainage bag hook is often first removed in practice. Once the winding between the connecting tube of the drainage bag and the mobile infusion stand has been adjusted, the drainage bag hook is re-installed, such that the connecting tube of the drainage bag no longer winds around the mobile infusion stand.

### BRIEF SUMMARY OF THE INVENTION

A conventional detachable hook element takes the ease of installation as a main consideration. In this case, a hook element is frequently designed as an integral C-shaped fastener for a user to directly fasten an opening of the C-shaped fastener at a mobile infusion stand. Although the design above is easy for a user to install, risks of pinching a user during a fastening process is also resulted. Moreover, when the weight hanging on the C-shape fastener is biased toward a certain point (or a certain side), weight imbalance of the hook element may be easily caused to lead to swinging or deformation. In addition, when the weight hanging on the C-shaped fastener is biased toward the other point opposite to the opening of the C-shaped fastener and the weight carried thereon is too large, loosening of the hook element from the mobile infusion stand may also be easily resulted.

Therefore, there is a need in the present technical field for a solution for solving the aforementioned issues encountered by a conventional hook element and for effectively improving the safety of a hook element and stability when the hook element is in an object hanging state.

To overcome the issues above, the present disclosure provides a hook assembly, including: a first combination element, having a first head protruding portion and a first tail connecting portion, wherein the first head protruding portion has a first front half engaging slot and the first tail connecting portion has a first rear half engaging slot; a second combination element, having a second head protruding portion and a second tail connecting portion, wherein the second head protruding portion has a second front half engaging slot and the second tail connecting portion has a second rear half engaging slot; a first object hanging element, having a first coupling portion, which is detachably connected at the first front half engaging slot of the first combination element and the second rear half engaging slot of the second combination element; and a second object hanging element, having a second coupling portion, which is detachably connected at the second front half engaging slot of the second combination element and the first rear half engaging slot of the first combination element.

In some embodiment, a cross section of the first coupling portion is H-shaped, and a cross section of the second coupling portion is H-shaped.

In some embodiments, at least one of the first combination element and the second combination element further has at least one additional hook channel operable for an additional object hanging element to be detachably connected at the at least one additional hook channel.

The present disclosure further provides an object hanging device, including: a body element, having an accommodating space, a first insert opening, a second insert opening and a groove portion, wherein the accommodating space passes through the body element, and the first insert opening and the second insert opening are individually in communication with the accommodating space; a driving element, movably connected at the body element, the driving element having a through opening which corresponds to the accommodating space of the body element; a first clamp element, movably inserted in the first insert opening and movably connected at the driving element; a second clamp element, movably inserted in the second insert opening and movably connected at the driving element; and a hook assembly, detachably connected at the groove portion of the body element, the hook assembly including: a first combination element, having a first head protruding portion and a first tail connecting portion, wherein the first head protruding portion has a first front half engaging slot and the first tail connecting portion has a first rear half engaging slot; a second combination element, having a second head protruding portion and a second tail connecting portion, wherein the second head protruding portion has a second front half engaging slot and the second tail connecting portion has a second rear half engaging slot; a first object hanging element, having a first coupling portion, which is detachably connected at the first front half engaging slot of the first combination element and the second rear half engaging slot of the second combination element; and a second object hanging element, having a second coupling portion, which is detachably connected at the second front half engaging slot of the second combination element and the first rear half engaging slot of the first combination element.

In some embodiment, a cross section of the first coupling portion is H-shaped, and a cross section of the second coupling portion is H-shaped.

In some embodiment, the body element includes: a first housing element, having an arc-shaped cross section, the first housing element having a first insert opening, an upper shaft fixing channel, a lower shaft fixing channel, an upper shaft positioning raised railing and a lower shaft positioning raised railing; and a second housing member, having an arc-shaped cross section, the second housing element having a second insert opening and a shaft fixing portion; wherein the first housing element is detachably connected at the second housing member; wherein when the first housing member is connected at the second housing member, the shaft fixing portion is pivotally connected at the upper shaft fixing channel and the lower shaft fixing channel; and wherein the upper shaft positioning raised railing is located at an opening of the upper shaft fixing channel and the lower shaft positioning raised railing is located at an opening of the lower shaft fixing channel.

In some embodiments, the first housing element further has an installation protrusion, the second housing element further has an engaging slot, and the body element further includes: a housing fastener, pivotally connected at the first housing element, the housing fastener having an installation recess and an engaging portion; wherein the installation recess corresponds to the installation protrusion of the first housing element and the engaging portion corresponds to the engaging slot of the second housing element; and wherein when the housing fastener is in an engaged state, the engaging portion is connected at the engaging slot of the second housing element.

In some embodiments, the first clamp element has on an inner side thereof a first connecting hole, the second clamp element has on an inner side thereof a second connecting hole, and the object hanging device further includes: a first washer, having a first connecting portion and a first clamp portion, wherein the first connecting portion corresponds to the first connecting hole of the first clamp element; and a second washer, having a second connecting portion and a second clamp portion, wherein the second connecting portion corresponds to the second connecting hole of the second clamp element; and wherein the first washer is detachably connected at the first clamp element, and the second washer is detachably connected at the second clamp element.

In some embodiments, the first connecting portion of the first washer has a first hook portion, the second connecting portion of the second washer has a second hook portion, the first clamp element further has a first hook opening which is in communication with the first connecting hole, the second clamp element further has a second hook opening which is in communication with the second connecting hole, and when the first washer and the second washer are individually in a washer connected state, the first connecting portion and the second connecting portion are connected at the first connecting hole and the second connecting hole, respectively, and the first hook portion and the second hook portion are engaged at the first hook opening and the second hook opening, respectively.

In some embodiments, the first clamp portion of the first washer has a first clamp surface, the second clamp portion of the second washer has a second clamp surface, and each the first clamp surface and the second clamp surface is formed of a material such as rubber, silicone or soft plastic.

In some embodiments, the first clamp surface of the first washer has at least one first protruding horizontal strip, and the second clamp surface of the second washer has at least one second protruding horizontal strip.

In some embodiments, an inner side of one other surface of the driving element relative to the body element has a convex arc shape.

In some embodiments, when the hook assembly is connected at the groove portion of the body element, the first front half engaging slot and the first rear half engaging slot of the first combination element and the second front half engaging slot and the second rear half engaging slot of the second combination element face the other side of a body portion of the body element.

In some embodiments, at least one of the first combination element and the second combination element further has at least one additional hook channel operable for an additional object hanging element to be detachably connected at the at least one additional hook channel.

In some embodiments, when the hook assembly is connected at the groove portion of the body element, at least a portion of the at least one additional hook channel is covered by the body element.

In some embodiments, when the object hanging device is in an object clamping state and an external device is located in the accommodating space and the through opening, the first clamp element and the second clamp element clamp the external device.

Thus, beneficial effects that could not be achieved by the prior art can be achieved by the technical means provided by the present disclosure. More specifically, one of the beneficial effects by the present disclosure is preventing pinching of a user by the configuration of the hook assembly, thereby improving user operation safety. Moreover, the stability of the hook assembly in an object hanging state is enhanced by the configuration of the hook assembly.

### BRIEF DESCRIPTION OF THE DRAWINGS

FIG. 1 is a perspective schematic diagram of a hook assembly according to an embodiment of the present disclosure.

FIG. 2A is a schematic diagram of a first combination element and a second combination element of the hook assembly shown in FIG. 1.

FIG. 2B is a schematic diagram of assembly of the hook assembly shown in FIG. 1.

FIG. 2C is a top view of the hook assembly shown in FIG. 1.

FIG. 3 is a perspective schematic diagram of an object hanging device according to an embodiment of the present disclosure.

FIG. 4 is an exploded schematic diagram of the object hanging device shown in FIG. 3.

FIG. 5A is a top view of the object hanging device shown in FIG. 3.

FIG. 5B is a section diagram of the object hanging device shown in FIG. 3.

FIG. 6A is a schematic diagram of a second housing element of a body element according to an embodiment of the present disclosure.

FIG. 6B is a schematic diagram of a first housing element of a body element according to an embodiment of the present disclosure.

FIG. 6C is a schematic diagram of a result of assembly of a body element according to an embodiment of the present disclosure.

FIG. 7A is a perspective schematic diagram of a housing fastener according to an embodiment of the present disclosure.

FIG. 7B is a section diagram of a connection relation between the housing fastener and the body element shown in FIG. 7a.

FIG. 8A is a bottom view of a driving element according to an embodiment of the present disclosure.

FIG. 8B is a front view of a connection relation between a first clamp element and a second clamp element shown in FIG. 8A.

FIG. 9A is a perspective schematic diagram of a first clamp element, a second clamp element, a first washer and a second washer according to an embodiment of the present disclosure.

FIG. 9B is a bottom view of the first clamp element, the second clamp element, the first washer and the second washer shown in FIG. 9A.

FIG. 10 is a perspective schematic diagram of the object hanging device in FIG. 3 in another assembly form.

### DETAILED DESCRIPTION OF THE INVENTION

In the following disclosure of the present disclosure, details of the present disclosure are given by way of the embodiments with reference to the accompanying drawings, so as to help a person skilled in the technical field pertinent to the present disclosure to better understand the objects, features and effects of the present disclosure.

It should be noted that, in the disclosure of the present disclosure, the terms such as “first”, “second” and “third” are used to distinguish differences among elements, and are not to be construed as limiting to the elements themselves and specific ordering of the elements. Moreover, it should also be noted that, in the disclosure of the description below, the same elements or steps can be represented by the same symbols or numerals.

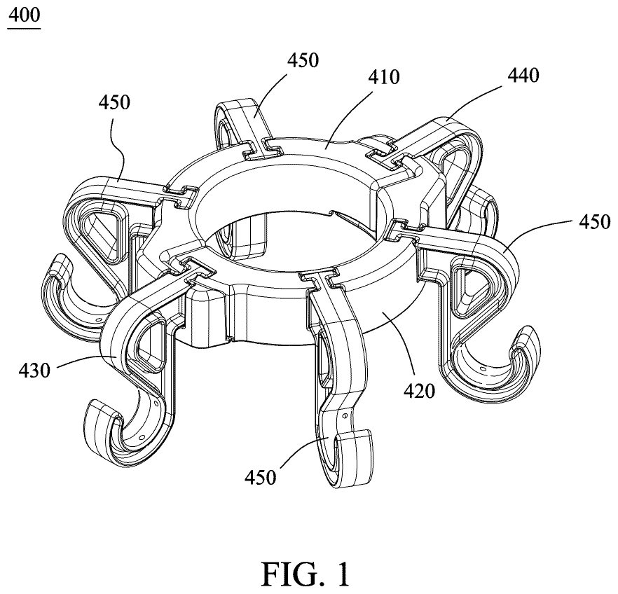

Refer to FIG. 1 showing a perspective schematic diagram of a hook assembly 400 according to an embodiment of the present disclosure. The hook assembly 400 of the present disclosure includes a first combination element 410, a second combination element 420, a first object hanging element 430 and a second object hanging element 440. The various structures of the hook assembly 400 of the present disclosure are to be described in detail below.

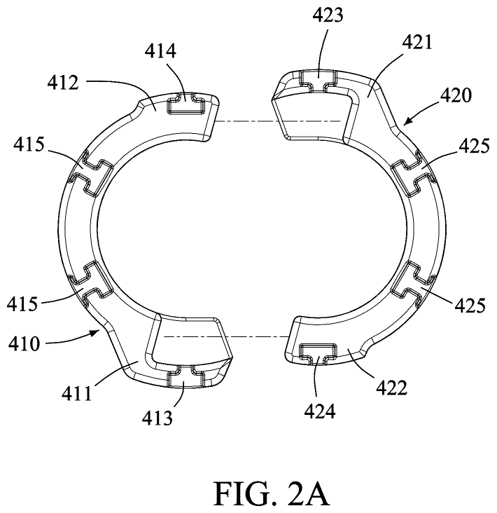

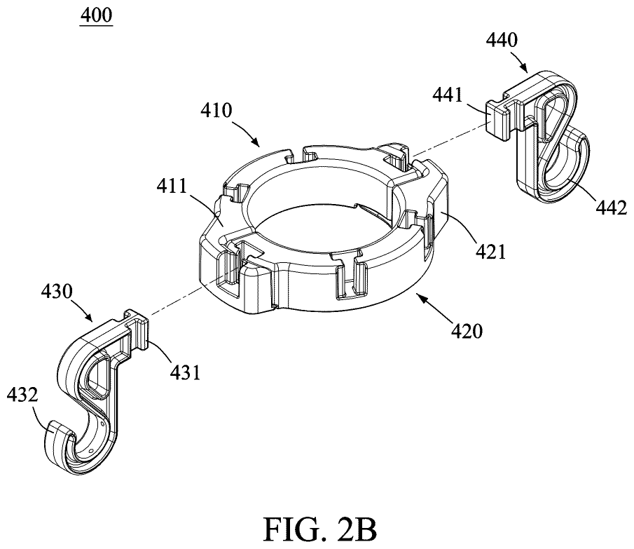

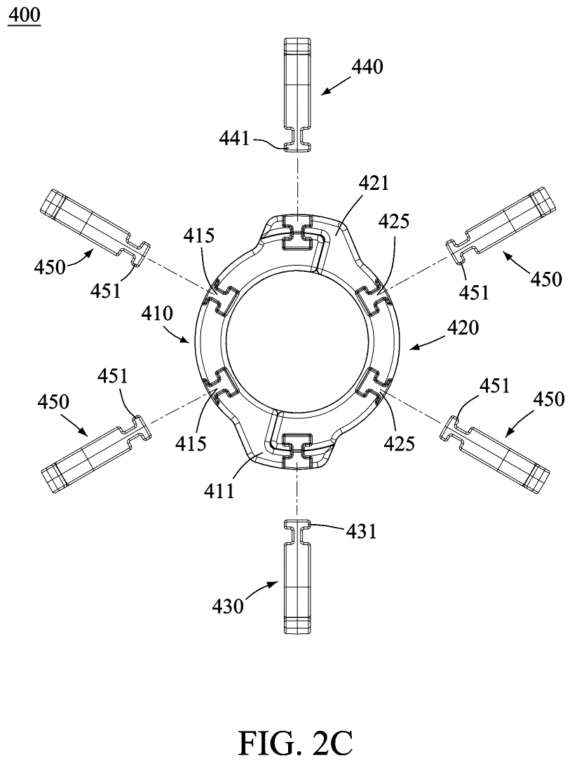

Referring to FIG. 2A to FIG. 2C, FIG. 2A shows a schematic diagram of the first combination element 410 and the second combination element 420 of the hook assembly 400 shown in FIG. 1, FIG. 2B shows a schematic diagram of assembly of the hook assembly 400 shown in FIG. 1, and FIG. 2C shows a top view of the hook assembly 400 shown in FIG. 1.

Taking FIG. 2A for example, the first combination element 410 has a first head protruding portion 411 and a first tail connecting portion 412, wherein the first head protruding portion 411 and the first tail connecting portion 412 are located on two different ends (that is, the first tail connecting portion 412 is located on the other end opposite to the first head protruding portion 411). Moreover, as shown in FIG. 2A, the first head protruding portion 411 protrudes further outside than the first combination element 410, so as to preserve an inner space for accommodating another combination element (for example, the second combination element 420). Further, the first head protruding portion 411 has a first front half engaging slot 413, and the first tail connecting portion 412 has a first rear half engaging slot 414, wherein each of the first front half engaging slot 413 and the first rear half engaging slot 414 is operable for a coupling portion of an object hanging element to be detachably connected. More specifically, the first front half engaging slot 413 is located outside the first head protruding portion 411, and the first rear half engaging slot 414 is located outside the first tail connecting portion 412.

Taking FIG. 2A for example, the second combination element 420 has a second head protruding portion 421 and a second tail connecting portion 422, wherein the second head protruding portion 421 and the second tail connecting portion 422 are located on two different ends (that is, the second tail connecting portion 422 is located on the other end opposite to the second head protruding portion 421). Moreover, as shown in FIG. 2A, the second head protruding portion 421 protrudes further outside than the second combination element 420, so as to preserve an inner space for accommodating another combination element (for example, the first combination element 410). Further, the second head protruding portion 421 has a second front half engaging slot 423, and the second tail connecting portion 422 has a second rear half engaging slot 424, wherein each of the second front half engaging slot 423 and the second rear half engaging slot 424 is operable for a coupling portion of an object hanging element to be detachably connected. More specifically, the second front half engaging slot 423 is located outside the second head protruding portion 421, and the second rear half engaging slot 424 is located outside the second tail connecting portion 422.

As shown in FIG. 2A, the first head protruding portion 411 of the first combination element 410 corresponds to the second tail connecting portion 422 of the second combination element 420, and the second head protruding portion 421 of the second combination element 420 corresponds to the first tail connecting portion 412 of the first combination element 410. A space sufficient for accommodating the second tail connecting portion 422 is preserved inside the first head protruding portion 411, and a space sufficient for accommodating the first tail connecting portion 412 is preserved inside the second head protruding portion 421, allowing the first combination element 410 and the second combination element 420 to be closely packed with each other. Further, in a closely packed state, as shown in FIG. 1 (or FIG. 2B or FIG. 2C), the first combination element 410 and the second combination element 420 can be closely packed into an enclosed loop, further allowing the first combination element 410 and the second combination element 420 to be detachably connected onto a device (for example, a groove portion of a body element of an object hanging device to be described below) adapted for the enclosed loop above.

Moreover, the first front half engaging slot 413 of the first combination element 410 corresponds to the second rear half engaging slot 424 of the second combination element 420, and the second front half engaging slot 423 of the second combination element 420 corresponds to the first rear half engaging slot 414 of the first combination element 410. Further, in a closely packed state, as shown in FIG. 2C, the first front half engaging slot 413 and the second rear half engaging slot 424 can form a first combined hook channel, and the second front half engaging slot 423 and the first rear half engaging slot 414 can form a second combined hook channel, wherein the first combined hook channel is operable for a first coupling portion 431 (to be described below) of the first object hanging element 430 to be detachably connected, and the second combined hook channel is operable for a second coupling portion 441 (to be described below) of the second object hanging element 440 to be detachably connected. In some embodiments, a cross section of the first combined hook channel and/or a cross section of the second combined hook channel may be in a shape generally known to a person of ordinary skill in the technical field of the present disclosure. In a preferred embodiment, as shown in FIG. 2C, the cross section of the first combined hook channel and/or the cross section of the second combined hook channel may be H-shaped. In this form, the first combined hook channel and/or the second combined hook channel may have a greater contact surface, so as to increase a contact area of the first combined hook channel when connected with the first coupling portion 431 to be described below and/or a contact area of the second combined hook channel when connected with the second coupling portion 441 to be described below, further allowing the first coupling portion 431 to be described below and/or the second coupling portion 441 to be described below be more securely connected at the first combined hook channel and/or the second combined hook channel, thereby enhancing the connection stability of the hook assembly 400.

As shown in FIG. 2B, the first object hanging element 430 has the first coupling portion 431, which is operable to be detachably connected to the first front half engaging slot 413 of the first combination element 410 and the second rear half engaging slot 424 of the second combination element 420 (that is, the first combined hook channel above). More specifically, one end of the first object hanging element 430 may protrude outward so as to form the first coupling portion 431. In some embodiments, a cross section of the first coupling portion 431 may be in a shape generally known to a person of ordinary skill in the technical field of the present disclosure. In a preferred embodiment, as shown in FIG. 2B and FIG. 2C, the cross section of the first coupling portion 431 may be H-shaped. In this form, a contact area of the first coupling portion 431 when connected with the first combined hook channel above can be increased, so as to prevent loosening (or sliding off) of the first coupling portion 431 and thus prevent the first coupling portion 431 from separating from the first combined hook channel, thereby enhancing the connection stability between the first coupling portion 431 and the first combined hook channel.

Moreover, the first object hanging element 430 further has a first hanging portion 432, which is operable for a user to hang various objects such as a drainage bag. More specifically, the other end of the first object hanging element 430 relative to the first coupling portion 431 may extend outward so as to form the first hanging portion 432. In some embodiments, the first hanging portion 432 may be a structure generally known to a person of ordinary skill in the technical field of the present disclosure. For example, the first hanging portion 432 may be a hook structure having an opening as shown in FIG. 2B.

As shown in FIG. 2B, the second object hanging element 440 has the second coupling portion 441, which is operable to be detachably connected to the second front half engaging slot 423 of the second combination element 420 and the first rear half engaging slot 414 of the first combination element 410 (that is, the second combined hook channel above). More specifically, one end of the second object hanging element 440 may protrude outward so as to form the second coupling portion 441. In some embodiments, a cross section of the second coupling portion 441 may be in a shape generally known to a person of ordinary skill in the technical field of the present disclosure. In a preferred embodiment, as shown in FIG. 2B and FIG. 2C, the cross section of the second coupling portion 441 may be H-shaped. In this form, a contact area of the second coupling portion 441 when connected with the second combined hook channel above can be increased, so as to prevent loosening (or sliding off) of the second coupling portion 441 and thus prevent the second coupling portion 441 from separating from the second combined hook channel, thereby enhancing the connection stability between the second coupling portion 441 and the second combined hook channel.

Moreover, the second object hanging element 440 further has a second hanging portion 442, which is operable for a user to hang various objects such as a drainage bag. More specifically, the other end of the second object hanging element 440 relative to the second coupling portion 441 may extend outward so as to form the second hanging portion 442. In some embodiments, the second hanging portion 442 may be a structure generally known to a person of ordinary skill in the technical field of the present disclosure. For example, the second hanging portion 442 may be a hook structure having an opening as shown in FIG. 2B.

With the configuration of the hook assembly 400 provided by the present disclosure, a user is allowed to more safety couple the first combination element 410 and the second combination element 420 by using the first object hanging element 430 and the second object hanging element 440, so as to prevent pinching of the user while the user connects the hook assembly 400 at an adapted device (for example, a groove portion of a body element of an object hanging device to be described below), thereby improving user operation safety. Meanwhile, the first object hanging element 430 and the second object hanging element 440 are also enabled to more securely couple the first combination element 410 and the second combination element 420, such that the hook assembly 440 is able to be more securely connected on an adapted device and preventing the loosening of the hook assembly 400 caused by weight imbalance of an object hanging thereon, thereby enhancing the stability of the hook assembly 400 in an object hanging state.

In some embodiments, the configuration of the first combination element 410 may be substantially the same as the configuration of the second combination element 420, so as to reduce manufacturing complications and manufacturing costs as well as effectively improving manufacturing efficiency. In some embodiments, a person of ordinary skill in the technical field of the present disclosure may select various suitable materials and molds to manufacture the first combination element 410 and/or the second combination element 420 in appropriate dimensions.

Similarly, in some embodiments, the configuration of the first object hanging element 430 may be substantially the same as the configuration of the second object hanging element 440, so as to reduce manufacturing complications and manufacturing costs as well as effectively improving manufacturing efficiency. In some embodiments, a person of ordinary skill in the technical field of the present disclosure may select various suitable materials and molds to manufacture the first object hanging element 430 and/or the second object hanging element 440 in appropriate dimensions.

Moreover, in some embodiments, at least one of the first combination element 410 and the second combination element 420 may further have an additional hook channel 415, which is operable for an additional object hanging element 450 to be described below to be detachably connected. As shown in FIG. 2A, the first combination element 410 may have, for example, two additional hook channels 415, and the second combination element 420 may have, for example, two additional hook channels 415. With the configuration of the additional hook channel 415, the number of object hanging elements connectable to the hook assembly 400 can be increased, thereby boosting the object hanging ability of the hook assembly 400. In some embodiments, a cross section of the additional hook channel portion 415 may be in a shape generally known to a person of ordinary skill in the technical field of the present disclosure. Taking FIG. 2A for example, the cross section of the additional hook channel 415 may be T-shaped.

Moreover, as shown in FIG. 1, in some embodiments, the hook assembly 400 may further include the additional object hanging element 450. Further, as shown in FIG. 2C, the additional object hanging element 450 has an additional coupling portion 451, which is operable to be detachably connected to the additional hook channel 415. More specifically, one end of the additional object hanging element 450 may protrude outward so as to form the additional coupling portion 451. Moreover, the additional object hanging element 450 further has an additional hanging portion, which is operable for a user to hang various objects such as a drainage bag. More specifically, the other end of the additional object hanging element 450 relative to the additional coupling portion 451 may extend outward so as to form the additional hanging portion. With the configuration of the additional object hanging element 450, the object hanging ability of the hook assembly 400 can be boosted for a user to hang more objects, thereby enhancing convenience for the user. In some embodiments, the configuration of the additional object hanging element 450 may be substantially the same as the configuration of the first object hanging element 430 and/or the second object hanging element 440, so as to reduce manufacturing complications and manufacturing costs as well as effectively improving manufacturing efficiency.

Moreover, in some embodiments, the various elements of the hook assembly 400 may be manufactured using symmetrical designs for a user to hang objects at relative positions, so that the hook assembly 400 is allowed to hang objects in a manner of balanced forces, thereby enhancing the stability of the hook assembly 400 in an object hanging state.

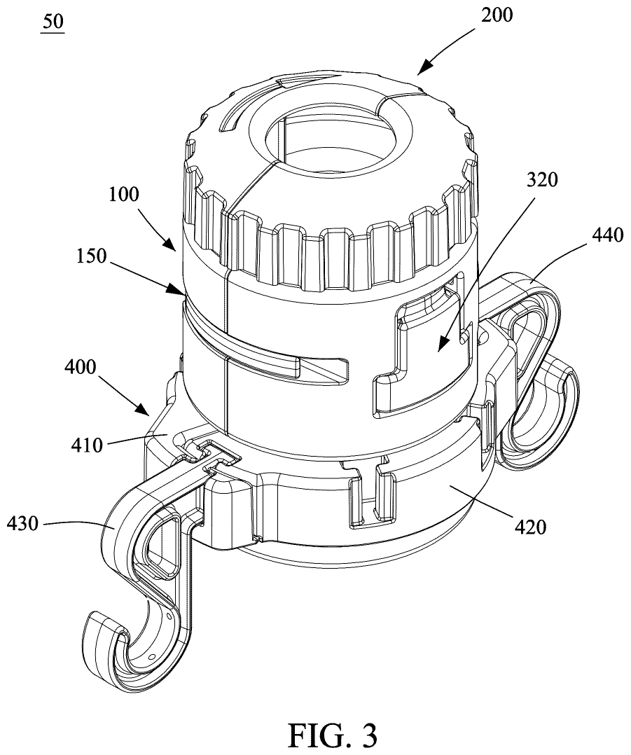

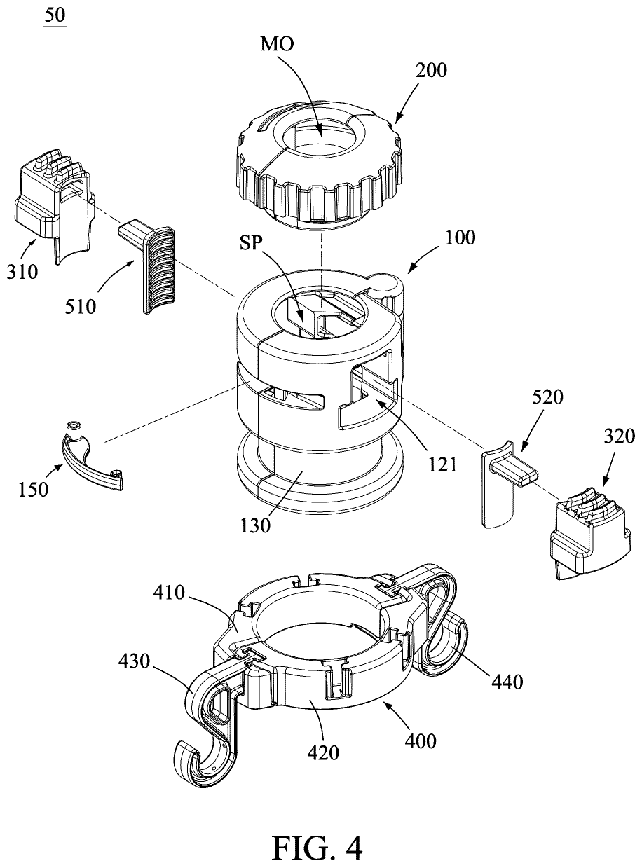

Referring to FIG. 3 and FIG. 4, FIG. 3 shows a perspective schematic diagram of an object hanging device 50 according to an embodiment of the present disclosure, and FIG. 4 shows an exploded schematic diagram of the object hanging device 50 shown in FIG. 3. The object hanging device 50 of the present disclosure includes a body element 100, a driving element 200, a first clamp element 310, a second clamp element 320 and the hook assembly 400 above. The various structures of the object hanging device 50 of the present disclosure are to be described in detail below. Moreover, as shown in FIG. 4, in some embodiments, the object hanging device 50 may further include a first washer 510 and a second washer 520.

The body element 100 has an accommodating space, a first insert opening, a second insert opening and a groove portion 130. The accommodating space passes through the body element 100, and the first insert opening and the second insert opening are individually in communication with the accommodating space. Moreover, as shown in FIG. 4, the groove portion 130 of the body element 100 is operable for the hook assembly 400 to be detachably connected. In other words, the first combination element 410 and the second combination element 420 of the hook assembly 400 can be tightly packed at the groove portion 130 of the body element 100, and the hook assembly 400 is subsequently connected to the groove portion 130 of the body element 100 by the first object hanging element 430 and the second object hanging element 440, so as to provide the body element 100 of the object hanging device 50 with an object hanging ability. Moreover, with the configuration of the hook assembly 400, user operation safety is improved, and the stability of the hook assembly 400 in an object hanging state is also enhanced.

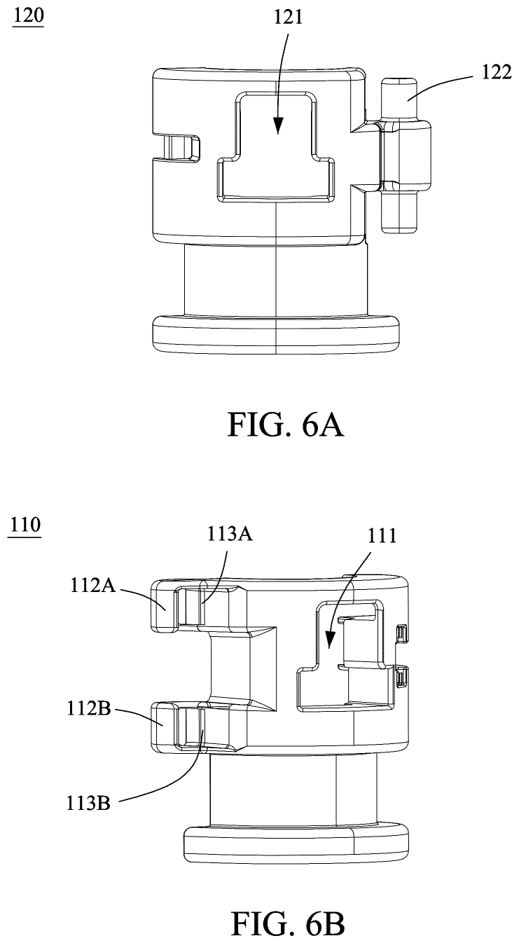

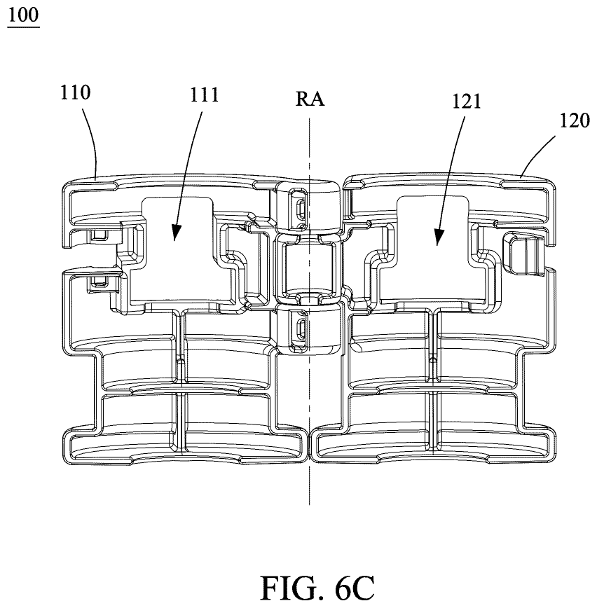

In some embodiments, the body element may be a one-piece structure, and more specifically, is an integrally formed body element. Moreover, in some other embodiments, the body element may be a combined structure, and more specifically, a two-piece combined or three-piece combined structure; however, the present disclosure is not limited to the examples above. The structure of a two-piece combined body element 100 is described in detail with reference to FIG. 6A to FIG. 6C below. On the other hand, the structure of a three-piece combined body element may include a left half housing element, a right half housing element and a fixing element, wherein the fixing element is operable to insert into a connecting portion of the left half housing element and a connecting portion of the right half housing element, so as to further connect the left half housing element and the right half housing element. In some embodiments, a person of ordinary skill in the technical field of the present disclosure may select various suitable materials and molds to manufacture the body element 100 in appropriate dimensions.

The driving element 200 is movably connected at the body element 100, and has a through opening MO. As shown in FIG. 3, the driving element 200 is located over the body element 100. When the driving element 200 is connected at the body element 100, the driving element 200 is operable by a user to move accordingly(for example, rotating). More specifically, when the driving element 200 is connected at the body element 100, a user may initiatively rotate the driving element 200 (that is, an active element), further guiding the first clamp element 310 (that is, a first passive element) and the second clamp element 320 (that is, a second passive element) in the object hanging device 50 to perform corresponding movements (for example, moving close to each other or moving away from each other). Moreover, as shown in FIG. 4, the through opening MO of the driving element 200 corresponds to an accommodating space SP of the body element 100, so as to preserve on an inside a space sufficient for accommodating an external device (for example, a mobile infusion stand).

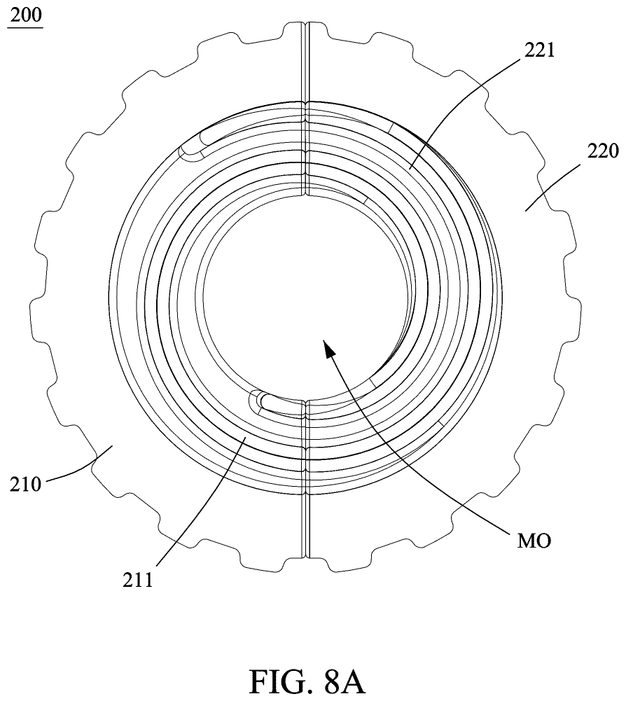

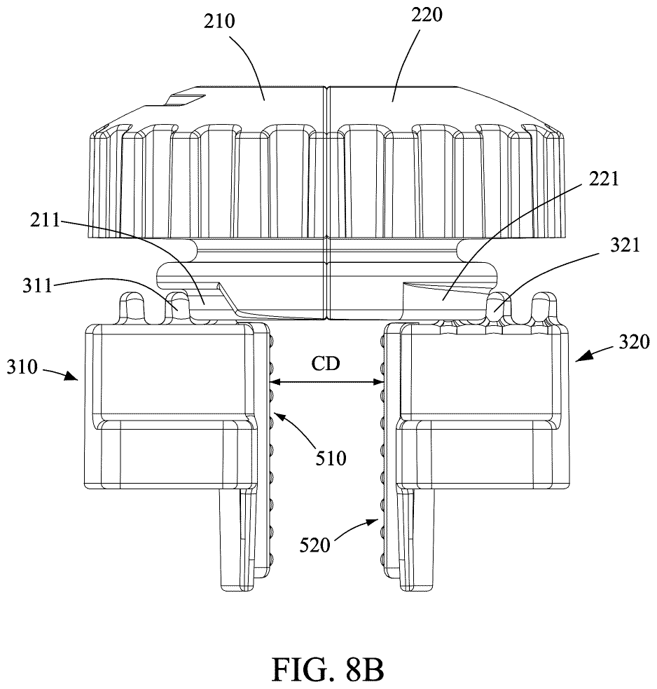

In some embodiments, the driving element may be a one-piece structure or a multi-piece (for example, two-piece) combined structure. The structure of the two-piece combined driving element 200 is to be described in detailed with reference to FIG. 8A and FIG. 8B below. In some embodiments, a person of ordinary skill in the technical field of the present disclosure may select various suitable materials and molds to manufacture the driving element 200 in appropriate dimensions.

The first clamp element 310 is movably inserted in the first insert opening of the body element 100, and is movably connected at the driving element 200. In some embodiments, the first clamp element 310 may be a block structure, and more specifically, a block structure having a cross section in a rectangular shape with a projection on one side as shown in FIG. 4. Since the size of the block structure of the first clamp element 310 is equivalent to that of the first insert opening of the body element 100, the first clamp element 310 is movable in the first insert opening of the body element 100 (for example, moving inside and outside). Moreover, one side (for example, an inner side) of the first clamp element 310 is longitudinally extendable (for example, extending downward) by a certain length so as to form an inner height greater than the height of the first insert opening of the body element 100, thereby preventing the first clamp element 310 from falling to the outside from the body element 100 during an operation process. In addition, one side (for example, an upper side) of the first clamp element 310 connected to the driving element 200 may protrude outward so as to form the first clamp element 310 having a first guide portion, further allowing the driving element 200 to guide the first clamp element 310 to perform a corresponding movement (for example, getting close to or getting away from a central line of the body element 100). Moreover, one side (that is, an inner side) of the first clamp element 310 close to the central line of the body element 100 may form a first clamp surface, so as to clamp and fix an external device (for example, a mobile infusion stand) accommodated in the accommodating space SP of the body element 100. In some embodiments, a person of ordinary skill in the technical field of the present disclosure may select various suitable materials and molds to manufacture the first clamp element 310 in appropriate dimensions.

The second clamp element 320 is movably inserted in the second insert opening 121 of the body element 100, and is movably connected at the driving element 200. In some embodiments, the second clamp element 320 may be a block structure, and more specifically, a block structure having a cross section in a rectangular shape with a projection on one side as shown in FIG. 4. Since the size of the block structure of the second clamp element 320 is equivalent to that of the second insert opening 121 of the body element 100, the second clamp element 320 is movable in the second insert opening 121 of the body element 100 (for example, moving inside and outside). Moreover, one side (for example, an inner side) of the second clamp element 320 is longitudinally extendable (for example, extending downward) by a certain length so as to form an inner height greater than the height of the second insert opening 121 of the body element 100, thereby preventing the second clamp element 320 from falling to the outside from the body element 100 during an operation process. In addition, one side (for example, an upper side) of the second clamp element 320 connected to the driving element 200 may protrude outward so as to form the second clamp element 320 having a second guide portion, further allowing the driving element 200 to guide the second clamp element 320 to perform a corresponding movement (for example, getting close to or getting away from a central line of the body element 100). Moreover, one side (that is, an inner side) of the second clamp element 320 close to the central line of the body element 100 may form a second clamp surface, so as to clamp and fix an external device (for example, a mobile infusion stand) accommodated in the accommodating space SP of the body element 100. In some embodiments, a person of ordinary skill in the technical field of the present disclosure may select various suitable materials and molds to manufacture the second clamp element 320 in appropriate dimensions.

With the configuration of the object hanging device 50 provided by the present disclosure, a user is enabled to more quickly adjust with better ease the height of the object hanging device 50 relative to the ground or the position thereof relative to an external device (for example, a mobile infusion stand), thereby increasing ease of operation for the user and allowing the user to perform related operations at an ergonomic height. Moreover, since the hook assembly 400 can be rotated in the groove portion 130 of the body element 100, a user is allowed to timely and appropriately rotate the hook assembly 400 to prevent pipelines (for example, a drainage tube of a drainage bag) of a hanging object from winding around an external device (for example, a mobile infusion stand), thereby promoting practicability of the object hanging device 50.

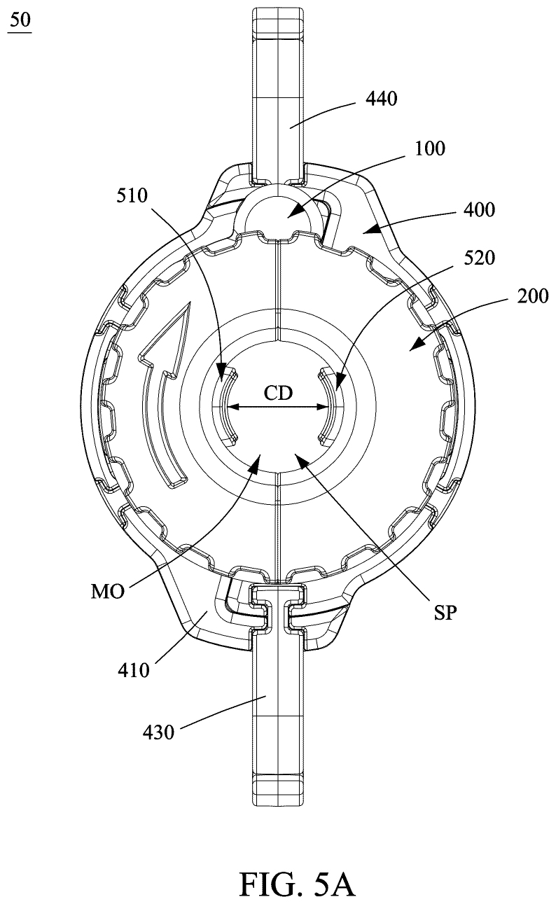

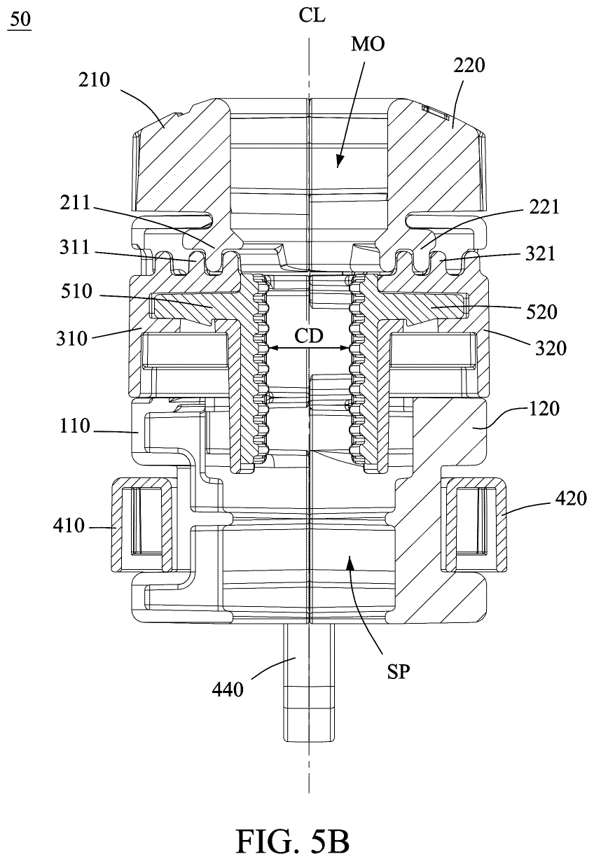

Referring to FIG. 5A and FIG. 5B, FIG. 5A shows a top view of the object hanging device 50 shown in FIG. 3, and FIG. 5B shows a section diagram of the object hanging device 50 shown in FIG. 3. As shown in FIG. 5A, the through opening MO corresponds to the accommodating space SP and is also in communication with the accommodating space SP, so as to insert an external device (for example, a mobile infusion stand) in the insert opening MO and the accommodating space SP, and accommodate the external device in the insert opening MO and the accommodating space SP. In continuation, the external device can be clamped in the insert opening MO and the accommodating space SP by the first clamp element 310 and the second clamp element 320, further allowing a user to operatively determine the height of the object hanging device 50 relative to the ground or the position thereof relative to the external device.

More specifically, with the operation (for example, rotating clockwise or rotating counterclockwise) of the driving element 200, a clamp distance CD between the first clamp element 310 and the second clamp element 320 can be correspondingly adjusted. For example, when a user rotates the driving element 200 clockwise, the first clamp element 310 and the second clamp element 320 may individually move toward a central line CL of the body element 100, further reducing the clamp distance CD between the first clamp element 310 and the second clamp element 320, so as to clamp and fix an external device accommodated in the accommodating space SP. Conversely, when a user rotates the driving element 200 counterclockwise, the first clamp element 310 and the second clamp element 320 may move in a direction opposite to the central line CL of the body element 100, further increasing the clamp distance CD between the first clamp element 310 and the second clamp element 320, so as to release a clamped and fixed external device. In addition, in some embodiments, when the object hanging device 50 further includes the first washer 510 and the second washer 520, since the object hanging device 50 may clamp and fix an external device further by the first washer 510 and the second washer 520, the clamp distance CD may be further defined as a distance between the first washer 510 and the second washer 520. Moreover, in some embodiments, a visible surface (for example, an upper surface) of the driving element 200 may be engraved with a movement indication (for example, an arrow representing clockwise rotation) of the driving element for a user to more intuitively operate the driving element 200, thereby promoting practicability of the object hanging device 50 and helping enhancing user experience.

Moreover, in some embodiments, the groove portion 130 is recessed by a certain depth toward the inside of the body element 100. In this form, when the hook assembly 400 having the additional hook channel 415 and the additional object hanging element 450 is connected at the groove portion 130 of the body element 100, at least a portion of the additional hook channel 415 and at least a portion of the additional object hanging element 450 may each be covered by the body element 100, so as to prevent the additional object hanging element 450 from unintentional disengagement during a process of use, thereby enhancing the stability of the hook assembly 400 in an object hanging state and promoting practicability of the object hanging device 50.

Further, a certain space may be preserved over the hook assembly 400 for a user to detachably connect the first object hanging element 430 and/or the second object hanging element 440 at the first combined hook channel and/or the second combined hook channel above, respectively. More specifically, spaces sufficient for accommodating the height of the first coupling portion and the height of the second coupling portion are preserved over the first combined hook channel and the second combined hook channel, respectively.

In addition, as shown in FIG. 5B, in some embodiments, the driving element 200 may be a two-piece combined structure. The driving element 200 may include a first moving element 210 and a second moving element 220, wherein the first moving element 210 has a first driving portion 211 and the second moving element 220 has a second driving portion 221. In this form, the first driving element 211 of the first moving element 210 is connected at a first guide portion 311 of the first clamp element 310 to further guide the first clamp element 310 to move close to or away from the central line CL of the body element 100. Meanwhile, the second driving portion 221 of the second moving element 220 is connected at a second guide portion 321 of the second clamp element 320 to further guide the second clamp element 320 to move close to or away from the central line CL of the body element 100. As such, a user may rotate the driving element 200 to operatively adjust the clamp distance CD, so as to clamp and fix (or loosen) an external device (for example, a mobile infusion stand) accommodated in the accommodating space SP of the body element 100. In other words, when the object hanging device 50 is in an object clamping state and an external device is located in the accommodating space SP and the through opening MO, the first clamp element 310 and the second clamp element 320 can clamp and fix the external device.

Referring to FIG. 6A to FIG. 6C, FIG. 6A shows a schematic diagram of a second housing element 120 of the body element 100 according to an embodiment of the present disclosure, FIG. 6B shows a schematic diagram of a first housing element 110 of the body element 100 according to an embodiment of the present disclosure, and FIG. 6C shows a schematic diagram of a result of assembly of the body element 100 according to an embodiment of the present disclosure. As shown in FIG. 6A to FIG. 6C, the body element 100 may be a two-piece combined structure, and may specifically include the first housing element 110 and the second housing element 120.

As shown in FIG. 6A, the second housing element 120 has the second insert opening 121, which is in communication with the accommodating space SP and is operable for accommodating the second clamp element 320 for the second clamp element 320 to move inside and outside the second insert opening 121. The second housing element 120 further has on one side thereof a shaft fixing portion 122, which is operable to be connected at an upper shaft fixing channel 112A and a lower shaft fixing channel 112B of the first housing element 110.

As shown in FIG. 6B, the first housing element 110 has a first insert opening 111, which is in communication with the accommodating space SP and is operable for accommodating the first clamp element 310 for the first clamp element 310 to move inside and outside the first insert opening 111. The first housing element 110 further has on one side thereof (one side adjacent to the shaft fixing portion 122 of the second housing element 120) the upper fixing channel 112A, the lower shaft fixing channel 112B, an upper shaft positioning raised railing 113A and a lower shaft positioning raised railing 113B. The upper shaft fixing channel 112A and the lower shaft fixing channel 112B are operable to accommodate the shaft fixing portion 122 of the second housing element 120, and the upper shaft positioning raised railing 113A and the lower shaft positioning raised railing 113B are operable to secure a connection relation of the shaft fixing portion 122 with the upper shaft fixing channel 112A and the lower shaft fixing channel 112B. In addition, taking FIG. 6B for example, the upper shaft positioning raised railing 113A is located at an opening of the upper shaft fixing channel 112A, and the lower shaft positioning raised railing 113B is located at an opening of the lower shaft fixing channel 112B. In this form, a user may align the shaft fixing portion 122 with the upper shaft fixing channel 112A and the lower shaft fixing channel 112B, and apply a force on the upper shaft fixing channel 112A and the lower shaft fixing channel 112B, such that the shaft fixing portion 122 passes through the upper shaft positioning raised railing 113A and the lower shaft positioning raised railing 113B, reaches the upper shaft fixing channel 112A and the lower shaft fixing channel 112B, and further connects the first housing element 110 and the second housing element 120. In continuation, when a user intends to separate the first housing element 110 and the second housing element 120, the user needs to apply a force in an opposite direction, so that the shaft fixing portion 122 passes through the upper shaft positioning raised railing 113A and the lower shaft positioning raised railing 113B and further departs from the upper shaft fixing channel 112A and the lower shaft fixing channel 112B. As such, with the configuration of the upper shaft positioning raised railing 113A and the lower shaft positioning raised railing 113B, the shaft fixing portion 122 of the second housing element 120 can be prevented from unintentional disengagement during an operation process, thereby enhancing the connection stability between the first housing element 110 and the second housing element 120.

In some embodiments, each of a cross section of the first housing element 110 and a cross section of the second housing element 120 may be arc-shaped, so as to preserve a certain space inside each of the first housing element 110 and the second housing element 120, further forming the accommodating space SP above. In some specific embodiments, a person of ordinary skill in the technical field of the present disclosure may select various suitable materials and molds to manufacture the first housing element 110 and the second housing element 120 in appropriate dimensions.

As shown in FIG. 6C, the first housing element 110 is detachably connected at the second housing element 120. Further, when the first housing element 110 is connected at the second housing element 120, the shaft fixing portion 122 is pivotally connected at the upper shaft fixing channel 112A and the lower shaft fixing channel 112B. In other words, a user may open or close the body element 100 by using a rotating shaft RA as an axis, allowing the user to timely and appropriately open or close the body element 100 according to user requirements (for example, cleaning requirements), thereby optimizing user operability. Moreover, since there is no need for designing or manufacturing a fixing member for connecting the first housing element 110 and the second housing element 120, such two-piece combined structure helps in reducing research and development costs as well as manufacturing costs.

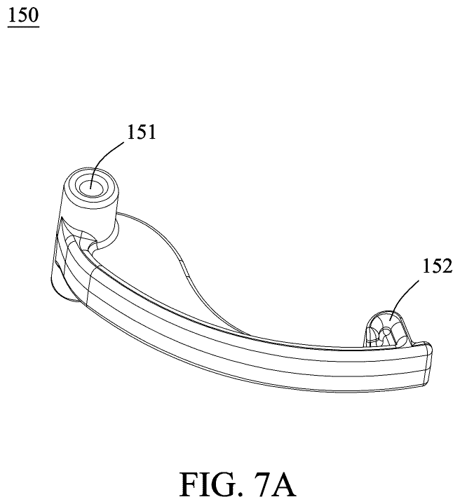

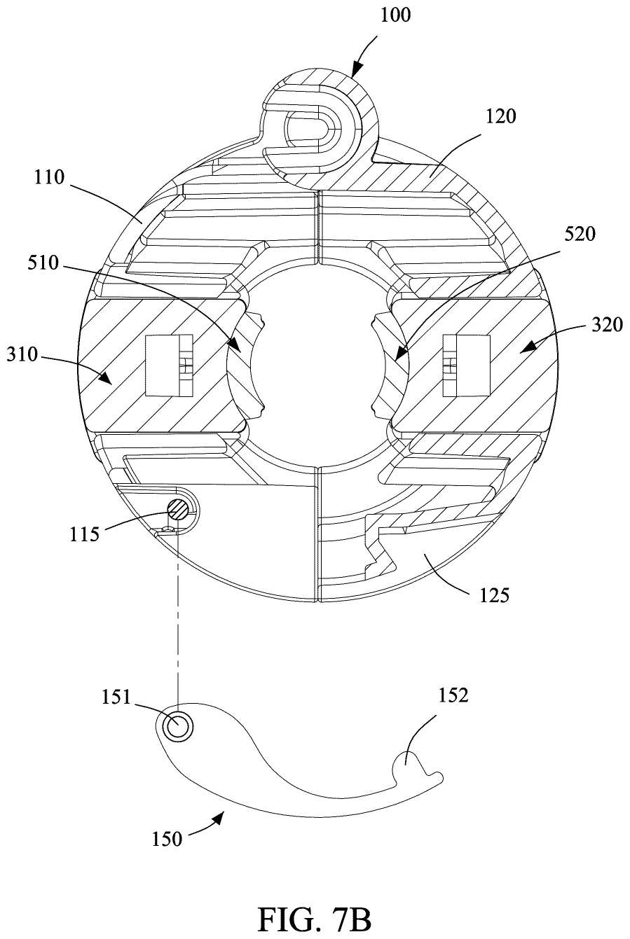

Referring to FIG. 7A and FIG. 7B, FIG. 7A shows a perspective schematic diagram of a housing fastener 150 according to an embodiment of the present disclosure, and FIG. 7B shows a section diagram of a connection relation between the housing fastener 150 shown in FIG. 7a and the body element 100.

The housing fastener 150 has an installation recess 151 and an engaging portion 152, wherein the installation recess 151 is operable to be pivotally connected at an installation protrusion 115 of the body element 100, and the engaging portion 152 is operable to be operatively connected at an engaging slot 125 of the body element 100. More specifically, the installation recess 151 is located on one side (for example, the left side) of the housing fastener 150, and the installation recess 151 corresponds to the installation protrusion 115 of the first housing element 110, so as to connect the housing fastener 150 at the installation protrusion 115 of the first housing element 110. In this form, a user may rotate the housing fastener 150 by using the installation recess 151 as an axis. Further, the engaging portion 152 is located on the other side (for example, the right side) relative to the installation recess 151, and the engaging portion 152 corresponds to the engaging slot 125 of the second housing element 120, so that whether the engaging portion 152 is to be connected at the engaging slot 125 can be determined according to a user operation. When the housing fastener 150 is in an engaged state, the engaging portion 152 is connected at the engaging slot 125 of the second housing element 120 to further lock the first housing element 110 and the second housing element 120, thereby enhancing the connection stability between the first housing element 110 and the second housing element 120 and preventing a user from unintentionally opening the first housing element 110 and the second housing element 120 during an operation process. In some specific embodiments, a person of ordinary skill in the technical field of the present disclosure may select various suitable materials and molds to manufacture the housing fastener 150 in appropriate dimensions.

Moreover, in some embodiments, the installation recess 151 may be further defined as an upper installation recess and a lower installation recess, wherein the upper installation recess may correspond to an upper installation protrusion and the lower installation recess may correspond to a lower installation protrusion. In other words, the upper installation recess is provided on an upper part of one side (for example, the left side) of the housing fastener 150 and the lower installation recess is provided on a lower part of the same side, so as to better connect the housing fastener 150 at the upper installation protrusion and the lower installation protrusion of the first housing element 110, thereby enhancing the connection stability between the housing fastener 150 and the first housing element 110 and preventing the housing fastener 150 from unintentional disengagement from the first housing element 110 during an operation process.

Referring to FIG. 8A and FIG. 8B, FIG. 8A shows a bottom view of the driving element 200 according to an embodiment of the present disclosure, and FIG. 8B shows a front view of a connection relation of the driving element 200 shown in FIG. 8A with the first clamp element 310 and the second clamp element 320.

In some embodiments, the driving element 200 may be a two-piece combined structure. The driving element 200 may include a first moving element 210 and a second moving element 220, wherein the first moving element 210 has a first driving portion 211 and the second moving element 220 has a second driving portion 221. Further, the driving element 200 has on a lower part thereof guide lines, which are operable to determine movement paths of the first guide portion 311 of the first clamp element 310 and the second guide portion 321 of the second clamp element 320. With the configuration of the guide lines, the first clamp element 310 and the second clamp element 320 are individually guided to move close to or away from the central line of the body element, allowing a user to operatively adjust the clamp distance CD.

Further, as shown in FIG. 8B, each of the parts of the first moving element 210 and the second moving element 220 close to the body element may be recessed inward by a certain space, so as to better connect the first housing element and the second housing element of the body element at the recessed parts at the lower parts of the first moving element 210 and the second moving element 220, respectively.

Moreover, in some embodiments, an inner side of one other surface of the driving element relative to the body element has a convex arc shape. As shown in FIG. 8B, an inner side of each of upper surfaces of the first moving element 210 and the second moving element 220 may be a convex arc shape for the palm of a user to rotate with an ergonomic shape matching the driving element, allowing the user to rotate the driving element with better ease of operation in a more effort-saving manner, thereby helping enhancing user experience.

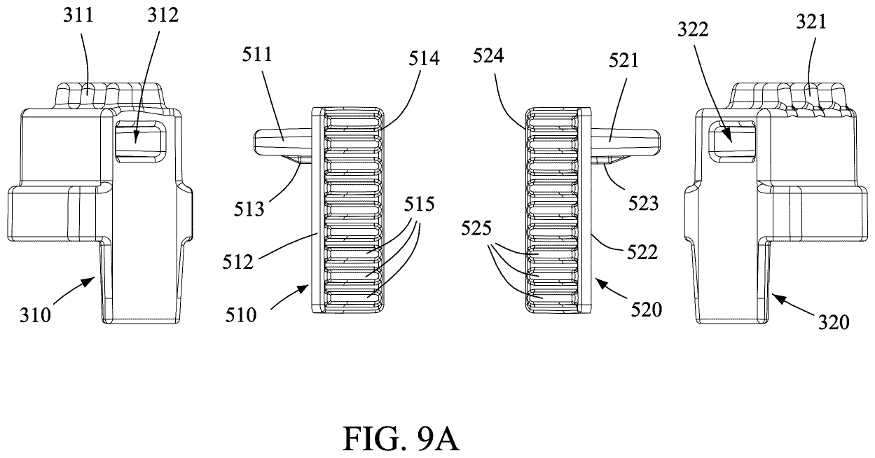

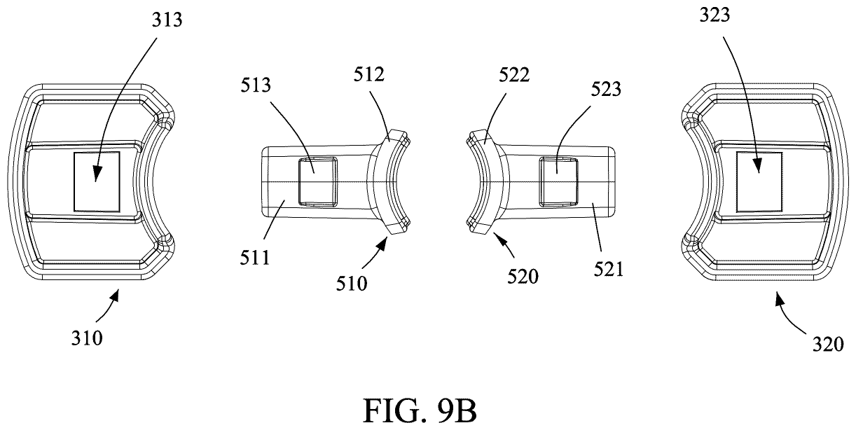

Referring to FIG. 9A and FIG. 9B, FIG. 9A shows a perspective schematic diagram of the first clamp element 310, the second clamp element 320, the first washer 510 and the second washer 520 according to an embodiment of the present disclosure, and FIG. 9B shows a bottom view of the first clamp element 310, the second clamp element 320, the first washer 510 and the second washer 520 shown in FIG. 9A.

The first clamp element 310 has on an inner side thereof a first connecting hole 312, and the first washer 510 has a first connecting portion 511 and a first clamp portion 512, wherein the first connecting portion 511 corresponds to the first connecting hole 312 (that is, the position and the size of an opening of the first connecting hole 312 match the first connecting portion 511), so as to better detachably connect the first clamp element 310 and the first washer 510. The first clamp portion 512 is operable to clamp an external device (for example, a mobile infusion stand) accommodated in the accommodating space of the body element, so as to prevent the external device from directly wearing the structure of the first clamp element 310 during a clamping process, thereby prolonging the durability of the first clamp element 310 and reducing the costs needed for frequently replacing the first clamp element 310. In other words, the first washer 510 may serve as a substitutive consumable so as to substitute for the first clamp element 310 to clamp and fix the external device above. More specifically, the first clamp portion 512 of the first washer 510 has a first clamp surface 514, so as to clamp the external device above by the first clamp surface 514.

The second clamp element 320 has on an inner side thereof a second connecting hole 322, and the second washer 520 has a second connecting portion 521 and a second clamp portion 522, wherein the second connecting portion 521 corresponds to the second connecting hole 322 (that is, the position and the size of an opening of the second connecting hole 322 match the second connecting portion 521), so as to better detachably connect the second clamp element 320 and the second washer 520. The second clamp portion 522 is operable to clamp an external device (for example, a mobile infusion stand) accommodated in the accommodating space of the body element, so as to prevent the external device from directly wearing the structure of the second clamp element 320 during a clamping process, thereby prolonging the durability of the second clamp element 320 and reducing the costs needed for frequently replacing the second clamp element 320. In other words, the second washer 520 may serve as a substitutive consumable so as to substitute for the second clamp element 320 to clamp the external device above. More specifically, the second clamp portion 522 of the second washer 520 has a second clamp surface 524, so as to clamp the external device above by the second clamp surface 524.

In some embodiments, a person of ordinary skill in the technical field of the present disclosure may select various suitable materials and molds to manufacture the first washer 510 and/or the second washer 520 in appropriate dimensions. Further, in a preferred embodiment, the material of the first clamp surface 514 of the first washer 510 and/or the material of the second clamp surface 524 of the second washer 520 may each be rubber, silicone or soft plastic, wherein the soft plastic may be, for example but not limited to, polypropylene (PP) or polyethylene (PE). Moreover, to increase the ease of manufacturing, the first washer 510 and/or the second washer 520 may be formed integrally of a material such as rubber, silicone or soft plastic. Further, a silicone material is suitable for medical apparatuses to meet related regulations of medical apparatus manufacturing; a rubber material features longer durability and a higher friction coefficient and is thus capable of enhancing the stability of the object hanging device 50 in an object hanging state and promoting the practicability of the object hanging device 50, as well as reducing the costs needed for frequent consumables replacement (that is, the first washer 510 and/or the second washer 520).

Moreover, in some embodiments, the first connecting portion 511 of the first washer 510 has a first hook portion 513, and the second connecting portion 521 of the second washer 520 has a second hook portion 523. In addition, the first clamp element 310 further has a first hook opening 313, and the second clamp element 320 further has a second hook opening 323, wherein the first hook opening 313 is in communication with the first connecting hole 312, and the second hook opening 323 is in communication with the second connecting hole 322. In this form, when the first washer 510 is in a connected state (that is, the first washer 510 is connected at the first clamp element 310), the first connecting portion 511 is connected at the first connecting hole 312, and the first hook portion 513 is engaged at he first hook opening 313, so as to better fix the position of the first washer 510 and prevent the first washer 510 from sliding off unintentionally during an operation process, thereby enhancing the connection stability between the first washer 510 and the first clamp element 310. Moreover, when the second washer 520 is in a connected state (that is, the second washer 520 is connected at the second clamp element 320), the second connecting portion 521 is connected at the second connecting hole 322, and the second hook portion 523 is engaged at the second hook opening 323, so as to better fix the position of the second washer 520 and prevent the second washer 520 from sliding off unintentionally during an operation process, thereby enhancing the connection stability between the second washer 520 and the second clamp element 320.

In addition, in some embodiments, the first clamp surface 514 of the first washer 510 has at least one first horizontal protruding strip 515, and the second clamp surface 524 of the second washer 520 has at least one second protruding horizontal strip 525, so as to increase a clamp force of the first clamp surface 514 and the second clamp surface 524, and prevent sliding off caused by smooth surfaces, thereby enhancing the stability of the object hanging device 50 in an object hanging state and promoting the practicability of the object hanging device 50.

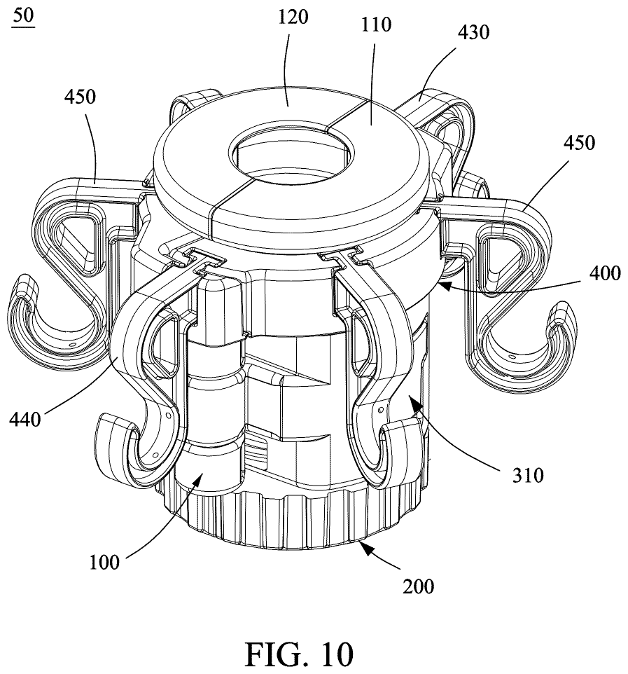

FIG. 10 shows a perspective schematic diagram of the object hanging device 50 in FIG. 3 in another assembly form. Different form the object hanging device 50 in FIG. 3, in the one shown in FIG. 10, the elements (that is, a body assembly) other than the hook assembly 400 are inverted in an assembled state, and then the hook assembly 400 is connected to the groove portion of the body element 100 of the inverted body assembly, so as to form another form of assembly for use of a user. In other words, when the hook assembly 400 is connected at the groove portion of the body element 100, the first front half engaging slot and the first rear half engaging slot of the first combination element and the second front half engaging slot and the second rear half engaging slot of the second combination element face the other side of a body portion of the body element, so as to form another assembly form different from that shown in FIG. 3. In this form, a user may move the hook assembly 400 of the object hanging device 50 to a higher position and ensure that the hook assembly 400 is distanced from the ground by a certain height, thereby promoting the practicability of the object hanging device 50 and increase operation flexibilities of the user.

Moreover, in this form, when the hook assembly 400 having the additional hook channel and the additional object hanging element 450 is connected at the groove portion of the body element 100, at least a portion of the additional hook channel and at least a portion of the additional object hanging element 450 may each be covered by the body element 100, so as to prevent the additional object hanging element 450 from unintentional disengagement during a process of use, thereby enhancing the stability of the hook assembly 400 in an object hanging state and promoting practicability of the object hanging device 50.

Although the present invention is described further in detail by way of specific embodiments and the accompanying drawings, numerous modifications and changes may be made by a person skilled in the technical field pertinent to the present invention without departing from the scope or spirit defined in the appended claims. Therefore, the scope of protection of the present invention should be accorded with the broadest interpretation of the appended claims and shall not be restricted by the invention of the detailed description.

What is claimed is:

1. A hook assembly, comprising:
a first combination element, having a first head protruding portion and a first tail connecting portion, wherein the first head protruding portion has a first front half engaging slot, and the first tail connecting portion has a first rear half engaging slot;
a second combination element, having a second head protruding portion and a second tail connecting portion, wherein the second head protruding portion has a second front half engaging slot, and the second tail connecting portion has a second rear half engaging slot;
a first object hanging element, having a first coupling portion, wherein the first coupling portion is detachably connected at the first front half engaging slot of the first combination element and the second rear half engaging slot of the second combination element; and
a second object hanging element, having a second coupling portion, wherein the second coupling portion is detachably connected at the second front half engaging slot of the second combination element and the first rear half engaging slot of the first combination element.

2. The hook assembly according to claim 1, wherein a cross section of the first coupling portion is H-shaped, and a cross section of the second coupling portion is H-shaped.

3. The hook assembly according to claim 1, wherein at least one of the first combination element and the second combination element further has:
at least one additional hook channel operable for an additional object hanging element to be detachably connected at the at least one additional hook channel.

4. An object hanging device, comprising:
a body element, having an accommodating space, a first insert opening, a second insert opening and a groove portion, wherein the accommodating space passes through the body element, and the first insert opening and the second insert opening are individually in communication with the accommodating space;
a driving element, movably connected at the body element, the driving element having a through opening which corresponds to the accommodating space of the body element;
a first clamp element, movably inserted in the first insert opening, and movably connected at the driving element;
a second clamp element, movably inserted in the second insert opening, and movably connected at the driving element; and
a hook assembly, detachably connected at the groove portion of the body element, the hook assembly comprising:
a first combination element, having a first head protruding portion and a first tail connecting portion, wherein the first head protruding portion has a first front half engaging slot, and the first tail connecting portion has a first rear half engaging slot;
a second combination element, having a second head protruding portion and a second tail connecting portion, wherein the second head protruding portion has a second front half engaging slot, and the second tail connecting portion has a second rear half engaging slot;
a first object hanging element, having a first coupling portion, wherein the first coupling portion is detachably connected at the first front half engaging slot of the first combination element and the second rear half engaging slot of the second combination element; and
a second object hanging element, having a second coupling portion, wherein the second coupling portion is detachably connected at the second front half engaging slot of the second combination element and the first rear half engaging slot of the first combination element.

5. The object hanging device according to claim 4, wherein a cross section of the first coupling portion is H-shaped, and a cross section of the second coupling portion is H-shaped.

6. The object hanging device according to claim 4, wherein the body element comprises:
a first housing element, having an arc-shaped cross section, the first housing element having the first insert opening, an upper shaft fixing channel, a lower shaft fixing channel, an upper shaft positioning raised railing and a lower shaft positioning raised railing; and
a second housing element, having an arc-shaped cross section, the second housing element having the second insert opening and a shaft fixing portion;
wherein the first housing element is detachably connected at the second housing element;
wherein when the first housing element is connected at the second housing element, the shaft fixing portion is pivotally connected at the upper shaft fixing channel and the lower shaft fixing channel; and
wherein the upper shaft positioning raised railing is located at an opening of the upper shaft fixing channel, and the lower shaft positioning raised railing is located at an opening of the lower shaft fixing channel.

7. The object hanging device according to claim 6, wherein the first housing element further has an installation protrusion, the second housing element further has an engaging slot, and the body element further comprises:
a housing fastener, pivotally connected at the first housing element, the housing fastener having an installation recess and an engaging portion;
wherein the installation recess corresponds to the installation protrusion of the first housing element, and the engaging portion corresponds to the engaging slot of the second housing element; and
wherein when the housing fastener is in an engaged state, the engaging portion is connected at the engaging slot of the second housing element.

8. The object hanging device according to claim 4, wherein the first clamp element has on
an inner side thereof a first connecting hole, the second clamp element has on an inner side thereof a second connecting hole, and the object hanging device further comprises:
a first washer, having a first connecting portion and a first clamp portion, wherein the first connecting portion corresponds to the first connecting hole of the first clamp element; and
a second washer, having a second connecting portion and a second clamp portion, wherein the second connecting portion corresponds to the second connecting hole of the second clamp element;
wherein the first washer is detachably connected at the first clamp element, and the second washer is detachably connected at the second clamp element.

9. The object hanging device according to claim 8, wherein
the first connecting portion of the first washer has a first hook portion;
the second connecting portion of the second washer has a second hook portion;
the first clamp element further has a first hook opening which is in communication with the first connecting hole;
the second clamp element further has a second hook opening which is in communication with the second connecting hole; and
when the first washer and the second washer are individually in a washer connected state, the first connecting portion and the second connecting portion are connected at the first connecting hole and the second connecting hole, respectively, and the first hook portion and the second hook portion are engaged at the first hook opening and the second hook opening, respectively.

10. The object hanging device according to claim 8, wherein the first clamp portion of the first washer has a first clamp surface, the second clamp portion of the second washer has a second clamp surface, and each the first clamp surface and the second clamp surface is formed of a material of rubber, silicone or soft plastic.

11. The object hanging device according to claim 10, wherein the first clamp surface of the first washer has at least one first protruding horizontal strip, and the second clamp surface of the second washer has at least one second protruding horizontal strip.

12. The object hanging device according to claim 4, wherein an inner side of one other surface of the driving element relative to the body element has a convex arc shape.

13. The object hanging device according to claim 4, wherein when the hook assembly is connected at the groove portion of the body element, the first front half engaging slot and the first rear half engaging slot of the first combination element and the second front half engaging slot and the second rear half engaging slot of the second combination element face one other side of a body portion of the body element.

14. The object hanging device according to claim 4, wherein at least one of the first combination element and the second combination element further has:
at least one additional hook channel operable for an additional object hanging element to be detachably connected at the at least one additional hook channel.

15. The object hanging device according to claim 14, wherein when the hook assembly is connected at the groove portion of the body element, at least a portion of the at least one additional hook channel is covered by the body element.

16. The object hanging device according to claim 4, wherein when the object hanging device is in an object clamping state and an external device is located in the accommodating space and the through opening, the first clamp element and the second clamp element clamp the external device.
